(19) United States
(12) Patent Application Publication
(10) Pub. No.: US 2007/0136123 A1
(43) Pub. Date: Jun. 14, 2007

(54) ELECTRONIC METHOD AND SYSTEM FOR MONITORING DESTINATION RAMP SYSTEMS

(75) Inventors: Julie Schiller, Royal Oak, MI (US); Arthur Joy, Norhtville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/275,117

(22) Filed: Dec. 12, 2005

(51) Int. Cl. G06F 17/00; G07G 1/00

(52) U.S. Cl. 705/10; 705/400

(57) ABSTRACT

A electronic method for monitoring one or more destination ramps in a manufacturing enterprise which manufactures a number of products for purchase through a number of dealers. The method includes the steps of receiving ramp profile information for one or more destination ramps and daily activity information for the one or more destinations ramps; and calculating a carrying cost for each of the one or more destination ramps based on the daily activity information.

### BACKGROUND OF THE INVENTION

1. Field of the Invention

One aspect of the present invention generally relates to an electronic method and system for monitoring destination ramp systems.

2. Background Art

A destination ramp system of a distributed manufacturing enterprise is often complicated and intricate. The destination ramp system typically includes final destination centers, transportation devices, destinations, and products.

A non-limiting example of a distributed manufacturing enterprise is an automobile manufacturer. In this context, as the vehicles (products) depart from assembly plants, the vehicles are sent to final destination centers, otherwise referred to as destination ramps, via rail, convoy or other transportation devices. From the destination ramps, the vehicles can be shipped to vehicle dealers (destinations) situated in geographically diverse locations, typically divided into a number of regions.

Automotive manufacturers devout substantial resources to the timely, efficient, and cost effective functioning of their destination ramp system because of the potential direct impact that the system has on the vehicle customer. For example, inefficient destination ramp systems can cause delays in the fulfillment of customer vehicle orders. Moreover, inefficient systems may result in the increase of vehicle transportation costs.

Automobile manufacturers typically track the performance of carriers, that is, the individuals responsible for the transportation devices, as a measure of destination range efficiency. Current proposals fall short of measuring the impact of carrier performance on the overall performance of the destination ramp system. For instance, traditionally, the metric of transit time is used to quantify carrier performance. However, this metric is difficult to translate into financial terms, for example, the translation of how relatively slow transit times affect the manufacturer costs.

Furthermore, current proposals do not sufficiently address the real time informational needs of automotive manufactures. Often, these companies need daily information regarding ramps. Gathering this information commonly takes longer than a day period. Moreover, obtaining this daily data and/or tracking carrier performance cause delays in the operation of the destination ramp system.

In light of the foregoing, an electronic method and system for monitoring destination ramp systems is needed that does not cause significant delays in the daily operation of the ramps. What is also needed is an electronic tool for generating regional reports and overall reports capturing a number of regions. Additionally, an electronic tool is needed for tracking performance from an assembly plant to a final destination.

### SUMMARY OF THE INVENTION

One aspect of the present invention is an electronic method and system for monitoring destination ramp systems. In certain aspects, the electronic method and system provides an efficient means for tracking performance from an assembly plant to a final destination. Another aspect of the present invention is a method and system for effectively determining the financial impacts of the operation of a destination ramp system. According to another aspect, a method and system is provided that generates usable, real-time and accessible information concerning a ramp destination system.

Ramp managers and logistics directors may find certain aspects of the present invention useful. Ramp managers can use the methods and systems of the present invention to gather and input day-to-day ramp activity information. Logistics directors can use the reporting methods and systems of the present invention to generate and view statistical summaries of several ramps in their region of responsibility. The methods and systems of the present invention can also be used to generate reports for individual ramps, for example, hot spots, for review by logistics directors.

According to a first embodiment of the present invention, an electronic method for monitoring a number of destination ramps in a manufacturing enterprise which manufactures a number of products for purchase through a number of dealers is disclosed. The method includes the steps of receiving ramp profile information for a number of destination ramps. The ramp profile information includes ramp contractor information. For each of the number of destination ramps, the method contemplates presenting a standardized electronic user interface for requesting and gathering destination ramp activity information including inbound product information and outbound convoy information. The standardized electronic user interface is standardized for use with all of the number of destination ramps. For each of the number of destination ramps, the method contemplates receiving the destination ramp activity information through the standardized electronic user interface. The method also includes populating an electronic database with the ramp profile information and the destination ramp activity information and calculating a carrying cost based on the ramp profile information and the destination ramp activity information. In certain embodiments, the receiving the destination ramp activity step, the populating step and the calculating step occur on a daily basis.

According to a second embodiment of the present invention, a computer-implemented method for monitoring one or more destination ramps in a manufacturing enterprise which manufactures a number of products for purchase through a number of dealers is disclosed. The method includes the steps of receiving ramp profile information for one or more destination ramps and daily activity information for the one or more destinations ramps; and calculating a carrying cost for each of the one or more destination ramps based on the daily activity information.

According to a third embodiment of the present invention, a computer system operating to monitor one or more destination ramps in a manufacturing enterprise which manufactures a number of products for purchase through a number of dealers is disclosed. The one or more computers is programmed to: receive ramp profile information for one or more destination ramps and daily activity information for the one or more destinations ramps; and calculate a carrying cost for each of the one or more destination ramps based on the daily activity information and transmit the one or more DFPs to the number of dealers.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings which:

FIG. 1 is a schematic diagram illustrating an overall environment suitable for implementing of one or more embodiments of the present invention;

FIG. 2 is a schematic diagram illustrating a computer system for implementing one or more embodiments of the present invention;

FIGS. 3a and 3b are a flowchart illustrating the process steps according to one or more embodiments of the present invention;

FIG. 4 is a graphical user interface (GUI) for inputting ramp profile information according to one or more embodiments of the present invention;

FIG. 5 is a GUI for selecting various features of the ramp destination monitoring system according one or more embodiments of the present invention;

FIG. 6 is a GUI for inputting activity information according to one or more embodiments of the present invention;

FIGS. 7a, 7b and 7c are GUIs for inputting inbound, inventory and pipeline activity information according to one or more embodiments of the present invention;

FIGS. 8a, 8b and 8c are GUIs for inputting dwell, delivery, and rail performance activity information according to one or more embodiments of the present invention;

FIGS. 9a and 9b are GUIs for inputting carhaul and injury staffing activity information according to one or more embodiments of the present invention;

FIG. 10 is a GUI for inputting comments according to one or more embodiments of the present invention;

FIG. 11 is an electronic activity report according to one or more embodiments of the present invention;

FIG. 12a is an electronic chart depicting ramp to dealer time in transit (TnT) according to one or more embodiments of the present invention;

FIG. 12b is an electronic chart depicting arrival and unload times versus selected dates according to one or more embodiments of the present invention;

FIG. 12c is an electronic chart depicting dealer floor plan (DFP) for delivered units versus date according to one or more embodiments of the present invention;

FIG. 13a is an electronic chart depicting actual and proposed arrival times versus date for one railroad according to one or more embodiments of the present invention;

FIG. 13b is an electronic chart depicting dwell time for vehicles in delivery versus date according to one or more embodiments of the present invention; and

FIG. 13c is an electronic chart summarizing comments according to one or more embodiments of the present invention.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. Therefore, specific functional details described herein are not to be interpreted as limiting, but merely as a representative basis for the claims and/or as a representative basis for teaching one of ordinary skill in the art to variously employ the present invention.

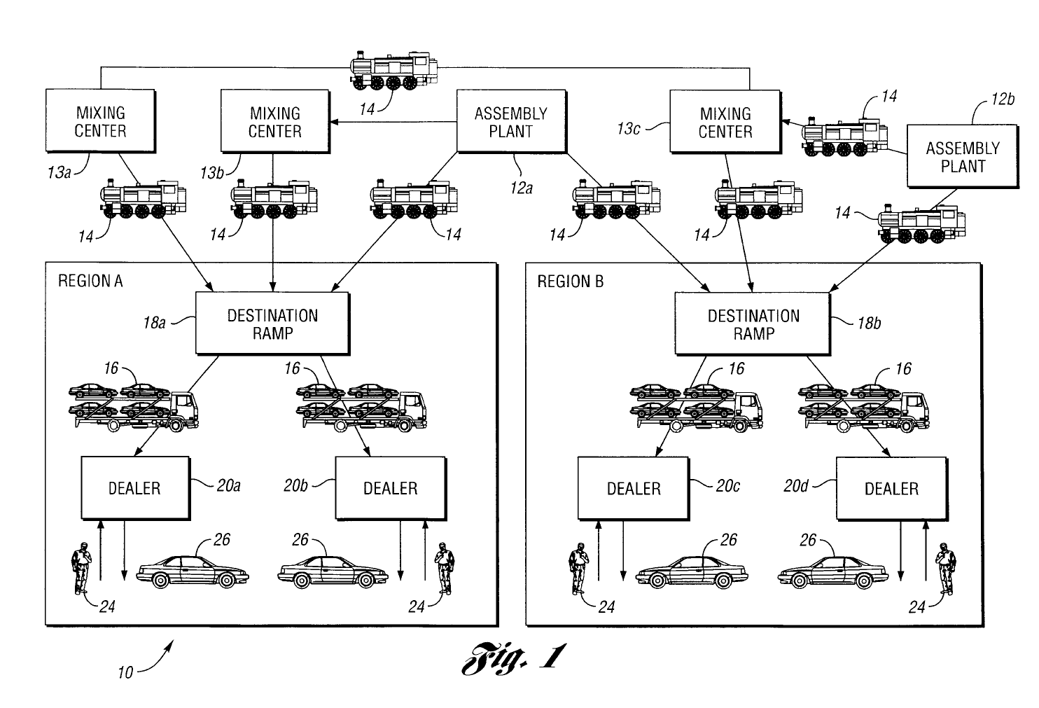

FIG. 1 depicts destination ramp system 10 suitable for implementing one or more embodiments of the present invention. Assembly plants 12a and 12b assemble automotive vehicles 26 for use by vehicle customers 24. Mixing centers 13a, 13b and 13c receive and mix vehicles assembled by assembly plants 12a and 12b. Vehicles 26 exiting each of the assembly plants 12a and 12b and the mixing centers 13a, 13b and 13c can be loaded onto railroad cars 14. It should be understood that shuttles (e.g., a number of vehicles driven in a group to the destination) and/or convoy vehicles can also transport vehicles. It should be understood that any or all of these modes of transportation can be used by each assembly plant and/or mixing center to transport assembled vehicles.

The vehicles 26 are transported from assembly plants 12a and 12b are mixing centers 13a, 13b and 13c to a number of destination centers, otherwise referred to herein as destination ramps. According to FIG. 1, assembly plant 12a and mixing centers 13a and 13b send at least some of its vehicles 26 to destination center 18a. Assembly plants 12a and 12b and mixing centers 13a and 13c send at least some of its vehicles 26 to destination center 18b.

Destination centers 18a and 18b mix and/or group the vehicles 26 for distribution to dealer 20a, 20b, 20c and 20d. The mixed and/or grouped vehicles are transported from destination centers 18a and 18b to a number of dealerships, typically via convoys 16, although railcars and/or shuttles can also be utilized.

Once the vehicles arrive from the destination ramps, the dealers 20a, 20b, 20c and 20d inspect the vehicles 26 and prepare them for display in their showrooms. These vehicles can then be viewed and purchased by vehicle customers 24. Alternatively, vehicles 26 arriving at the dealer may have already been purchased by customers 24 via an Internet store front or via special order, for example. These vehicles 26 are delivered directly to the customer without being placed in the showroom. In either scenario, aspects of the present invention can monitor the flow of vehicles 26 from the assembly plants 12a, 12b, 12c and 12d to dealers 20a, 20b, 20c and 20d and customers 24.

As depicted in FIG. 1, destination center 18a, and dealers 20a and 20b are geographically located in region 22a. Destination center 18b, and dealerships 20c and 20d are geographically located in region 22b. In certain embodiments, the present invention can monitor the flow of vehicles on a regional level.

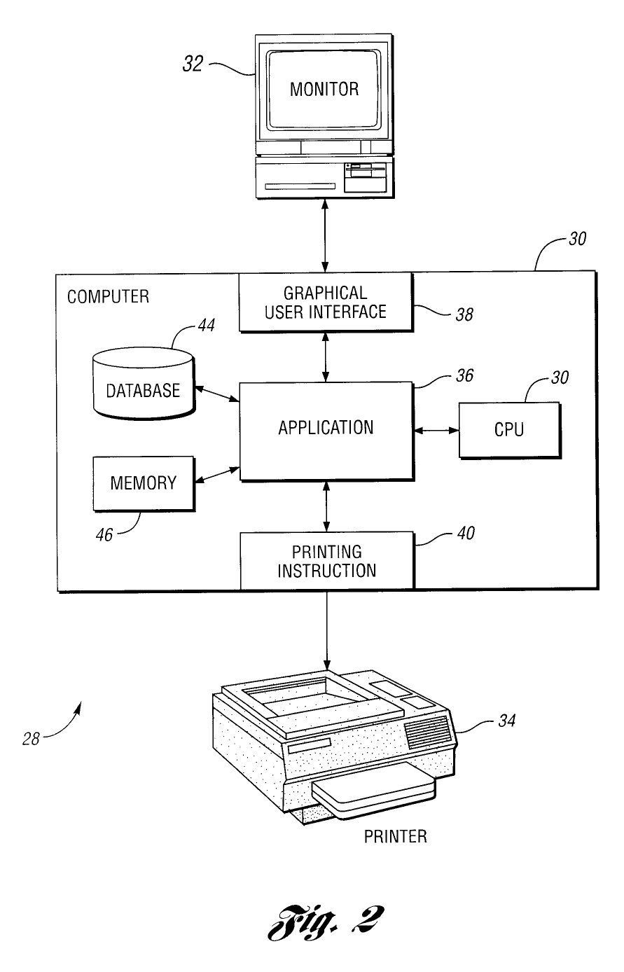

In certain embodiments of the present invention, a method and system for tracking and monitoring the flow of the vehicles through destination ramp system 10 is disclosed. The method and system can be computer implemented with the computer system 28 depicted in FIG. 2. Computer system 28 includes computer 30, monitor 32 and printer 34. Computer 30 can be selected from various types of computers, including, but not limited to, notebooks, desktops, workstations, mainframes, handhelds, personal digital assistants (“PDAs”), etc. Monitor 32 and printer 34 can be integrated into computer 30 or each or both can be stand-alone devices electronically connected to computer 30.

Application 36 can be a software application which is installed on computer 30. Although various software applications can be used in accordance with the present invention, in certain embodiments, application 36 is suitable to generate one or more graphical user interfaces (GUIs) for display on monitor 36. In certain embodiments, application 36 is capable of generating printing instructions 40 for transmission to printer 34. Application 36 can also have capabilities to send and receive instructions from central processing unit (CPU) 42, and transmit and receive data from database 44 and memory 46.

A non-limiting example of a software application suitable for use with the present invention is a spreadsheet program with macro functionality, for example, Microsoft Excel or Coral Quattro Pro. In certain embodiments, Microsoft Excel is utilized to implement methods and systems of the present invention. Another example of a software application suitable for use with the present invention is a database application supporting structured query language (SQL). An example of such an application is Microsoft Access. Web-based applications can also be used in accordance with the present invention, for example, active server pages (ASP), active X content and/or Java scripts.

It should be understood that the software application 36 and database 44 should be flexible and robust enough to take into account slight changes in the destination ramp system. For example, the information on regional locations of a ramp, carrier, and/or ramp manager may change occasionally. Database 44 can be relational so that it can be easily updated to accommodate changes in the ramp profile.

Computer 30 can be configured to be interconnected to a network, for example, a local area network (LAN) or wide area network (WAN), through a variety of interfaces, including, but not limited to dial-in connections, cable modems, high-speed lines, and hybrids thereof. Firewalls can be connected in any communication path to protect certain parts of the network from hostile and/or unauthorized use.

Computer 30 can support TCP/IP protocol which has input and access capabilities via two-way communication lines. The communication lines can be an intranet-adaptable communication line, for example, a dedicated line, a satellite link, an Ethernet link, a public telephone network, a private telephone network, and hybrids thereof. The communication lines can also be intranet-adaptable. Examples of suitable communication lines include, but are not limited to, public telephone networks, public cable networks, and hybrids thereof.

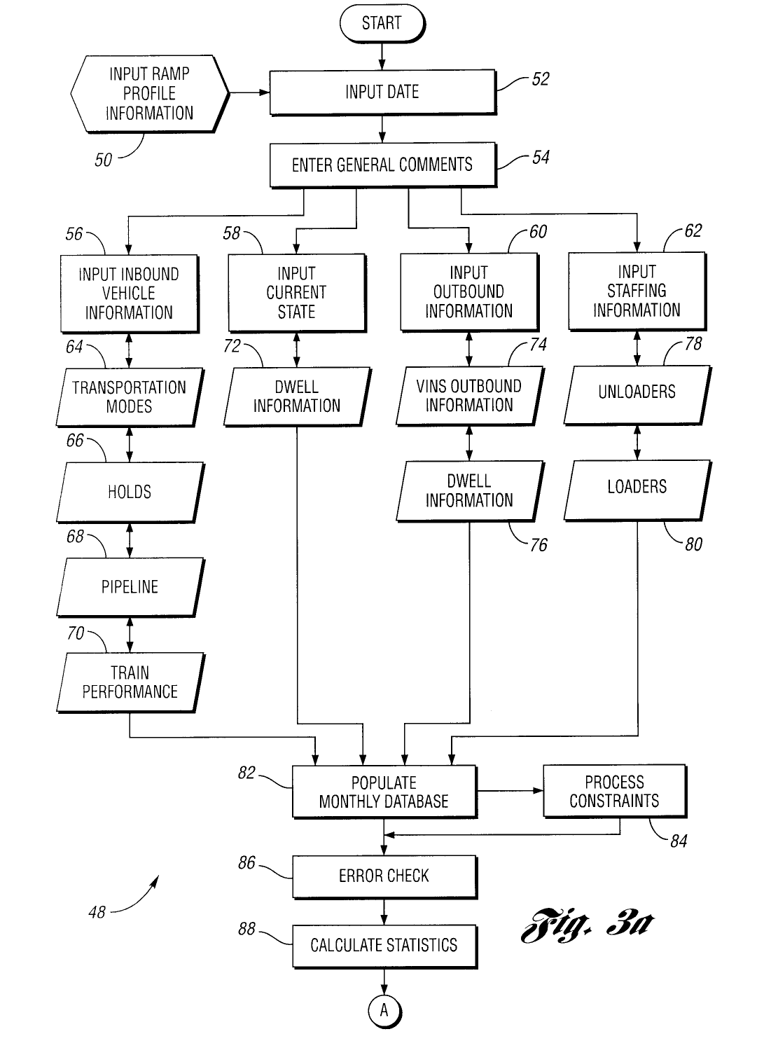

FIGS. 3a and 3b depict flowchart 48 of the method steps according to one embodiment of the present invention. It should be understood that elements and/or blocks of flowchart 48 can be rearranged, removed, and/or revised depending upon the implementation of the present invention. In block 50 of flowchart 48, ramp profile information relating to a destination ramp is input. In certain embodiments, the ramp profile information can be input through a graphical user interface (GUI) generated by application 36 and displayed on monitor 36.

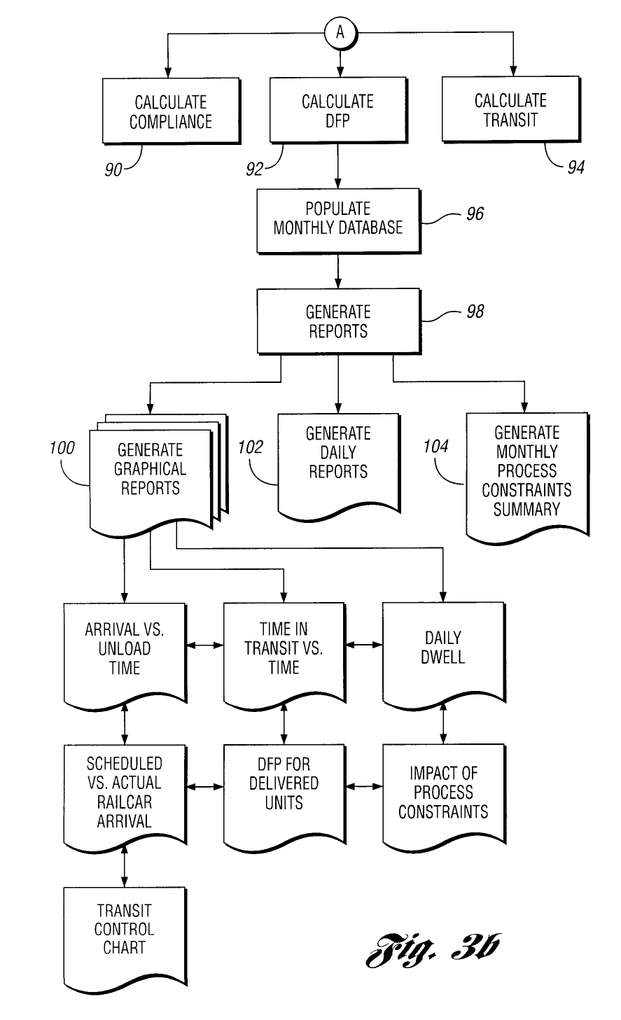

FIG. 4 is a GUI 100 for inputting ramp profile information. GUI 100 can be displayed as a Microsoft Excel worksheet. GUI 100 includes ramp profile tab 102, dealer floor plan tab 104, inbound railroads tab 106, vehicle unload tab 108 and staffing tab 110. Ramp profile tab 102 includes a column 112 of data entry fields for inputting ramp profile information, for example, destination ramp name, current month, shuttle contractor(s), convoy contractor(s), rail yard capacity, convoy yard capacity, shuttle capacity, batch and hold information (input in hours and/or days), load factor (input in vehicles per load) and target units per hour rate. Dealer floor plan tab 104 includes data entry field 114 for inputting average dealer floor plan overall expense (input in dollars or other currency). An average expense, i.e. average carrying cost, can be calculated by multiplying total dwell (in time) by carrying cost (in currency per time) and dividing by total inventory (in number of vehicles). In certain embodiments, the cost value can be based on a calendar year dealer floor plan (“DFP”) value. The DFP can be calculated for each vehicle line, and can be used in association with computing an average cost to hold a car in the destination ramp system and not to sell it.

Inbound railroads tab 106 includes a column 116 of data entry fields for inputting one or more railroads used by the destination ramp. According to FIG. 4, two railroads are in use, i.e., Norfolk Southern and CSX.

The vehicle unload tab 108 and staffing tab 110 can be used to input production and staffing variations, respectively. Vehicle unload tab 108 includes cell columns 118 and 120 for inputting minimum and maximum allowable variations, respectively, for each category reflected in the intersecting row. Minimum and maximum allowable variations can be entered for rail, convoy and shuttle unloading (in minutes); compliance (in days) for shippable units and delivered units; the rail performance (in number of rail cars) for each railroad input into column 116; and rail arrival time variations for each railroad input into column 116. Staffing tab 110 includes cell columns 122 and 124 for inputting minimum and maximum allowable variations for each category listed in the intersecting row. Cell columns 122 and 124 can be used to input minimum and maximum allowable variations for carhaul operations (employees, units per man (UPM) rate, total hours and total units processed) and injuries related to rail and convoy operations.

“Update Profile” click button 126 can be used to store additions, deletions and/or revisions made to the ramp profile information stored in database 44. “Clear” click button 128 can be used to clear the contents of the data entry fields on GUI 100.

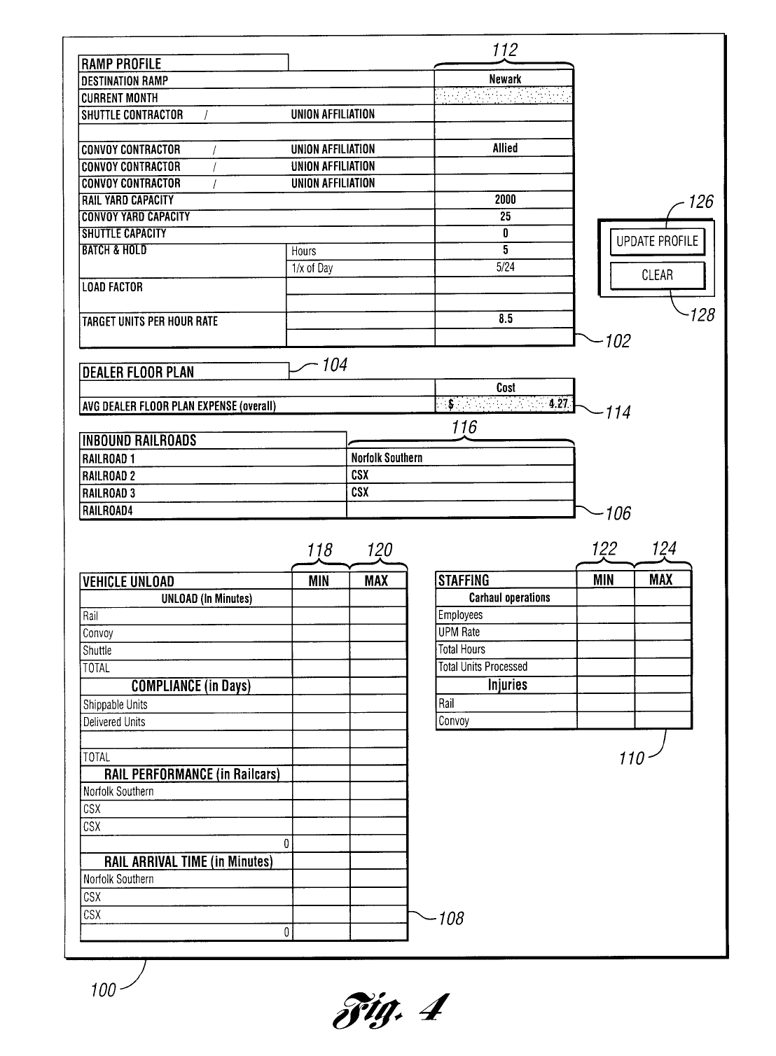

Turning to FIG. 3a again, the next process step, as depicted in block 52, is inputting a date, which is the date relating to the entry of activity information as described below. The date can be input through a GUI. In certain embodiments, GUI 200 of FIG. 5 can be used to access another GUI for inputting the date and related activity information. The “Enter Data” click button 202 can be selected by the user so that the application 36 generates a GUI for inputting a date and related activity information. GUI 200 also includes “HELP” click button 204, “Best Practices” click button 206, “Display Comments” click button 208, “Display Daily Data” click button 210 and “Display Graphs” click button 212. Each of these click buttons can be selected to access a function of certain embodiments of the present invention, as described in detail below.

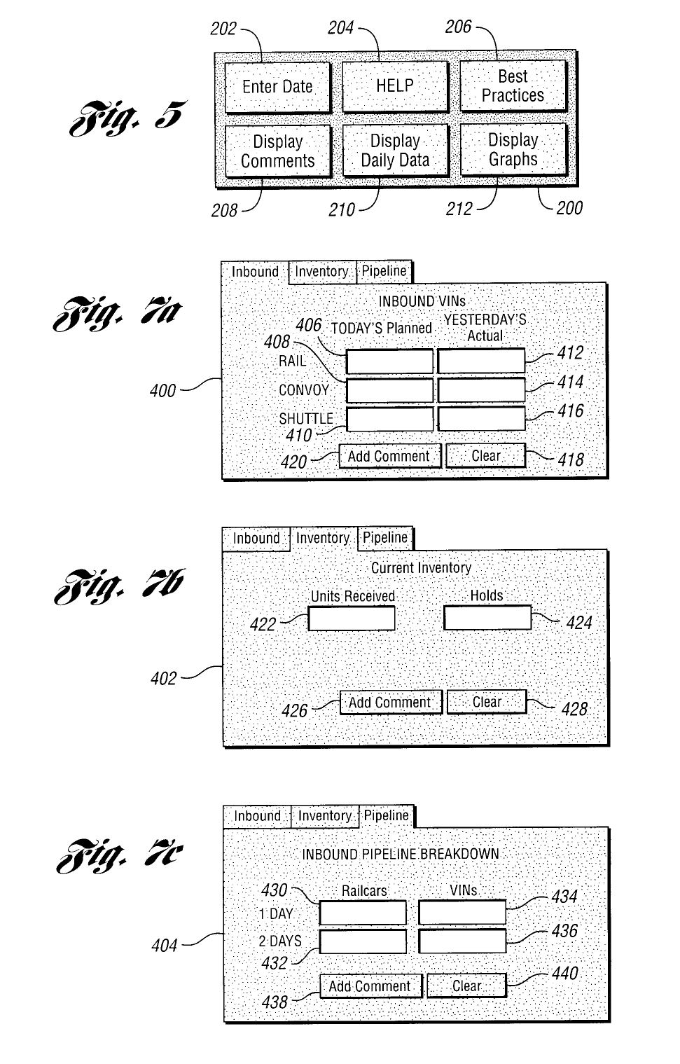

The “Enter Data” click button 202 can be selected to display activity reporting GUI 300 of FIG. 6. To activate the activity reporting GUI 300, the user enters a date by selecting a month in month drop down box 302 and a day of the month in day drop down box 304. The activity reporting GUI 300 presents a standardized user interface for gathering destination ramp activity information. GUI 300 can be used by ramp managers and logistics directors to input information regarding any destination ramp in a destination ramp system. As such, the data collection is standardized, and therefore comparisons and reporting of regional and ramp data is possible. Once these two values are selected, the “Enter Date” click button can be selected to activate the applicable content on GUI 300.

According to block 54 of FIG. 3a, general comments can be entered regarding the activity reporting function, which can be input in text box 308 of GUI 300.

Once GUI 300 is activated, the user can input various pieces of information regarding the activity on the date entered. This information can include inbound vehicle information, current state information, outbound information, and staffing information, which can be input as reflected in blocks 56, 58, 60 and 62. Non-limiting examples of inbound vehicle information include transportation modes 64, holds 66, pipeline 68 and train performance 70. A non-limiting example of current state information includes dwell information 72. Non-limiting examples of outbound information include vehicle identification numbers (VINs) outbound information 74 and dwell information 76. Non-limiting examples of staffing information include unloaders 78 and loaders 80.

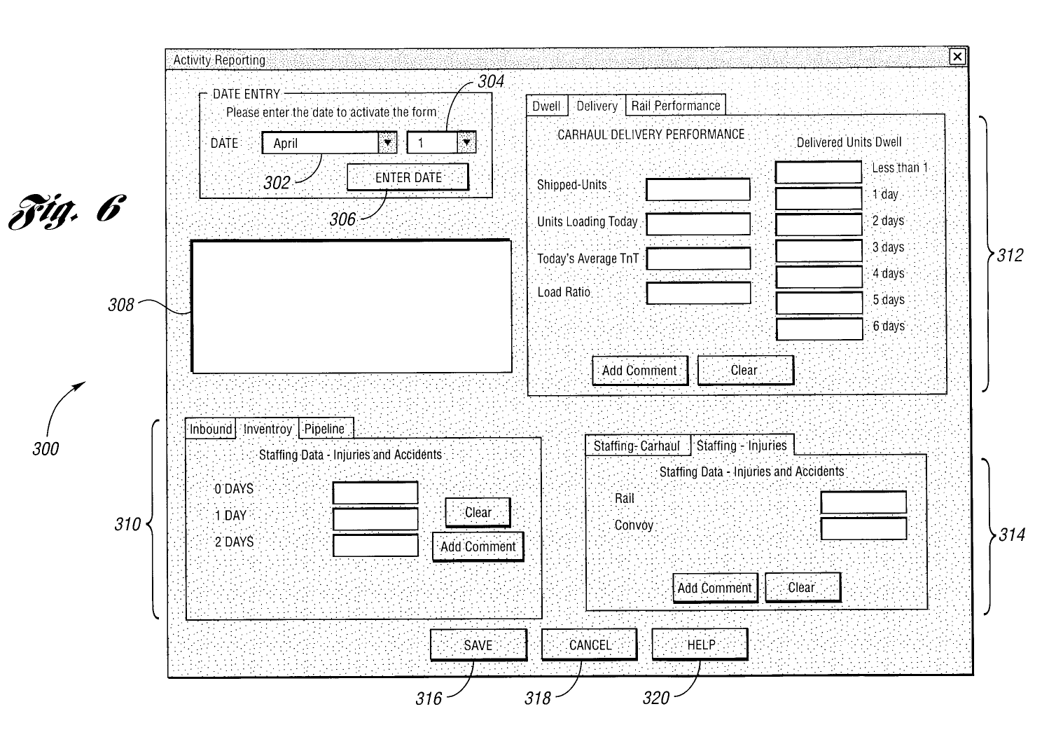

GUI 300 includes a number of tabbed areas 310, 312 and 314 for facilitating the input of the activity information identified in blocks 56, 58, 60 and 62. Tabbed area 310 includes inbound tab 400, as depicted in FIG. 7a, inventory tab 402, as depicted in FIG. 7b, and pipeline tab, as depicted in FIG. 7c.

Inbound tab 400 can be used to input daily statistics on vehicles unloaded from various modes of transportation. The number of inbound VINs, i.e. vehicles, planned for unload on the activity date via rail, convoy and shuttle can be input through data entry fields 406, 408 and 410. The actual number of inbound VINs unloaded the previous day via rail, convoy and shuttle can be input through data entry fields 412, 414 and 416. The information input through inbound tab 400, as well as the other input tabs, can be stored to database 44 by application 36. In other embodiments, a flat file including a list of VINs for each inbound VIN category can be generated. A subroutine can be used to automatically format the VIN level flat file data for storage in database 44.

The values entered in data entry fields 406, 408, 410, 412, 414 and 416 can be cleared by clicking on the “Clear” click button 418. A comment can be added to any field by clicking on the “Add Comment” click button 420.

Inventory tab 402 can be used to input the total units counted as received at the destination ramp on the activity date and the number of holds. Input fields 422 and 424 can be used to input the units received and number of holds, respectively. Inventory tab 402 also includes “Add Comment” and “Clear” click buttons 426 and 428, which function similar to click buttons 418 and 420.

Pipeline tab 404 can be used to input pipeline information, i.e. a forecast of units arriving at the destination ramp on the activity date and over the next two days. The number of forecasted units arriving via rail car on the activity date and over the next two days can be input through data entry fields 430 and 432, respectively. The number of forecasted units arriving in total on the activity date and over the next two days can be input through data entry fields 434 and 426. Pipeline tab 404 also includes “Add Comment” and “Clear” click buttons 426 and 428, which function similar to click buttons 438 and 440.

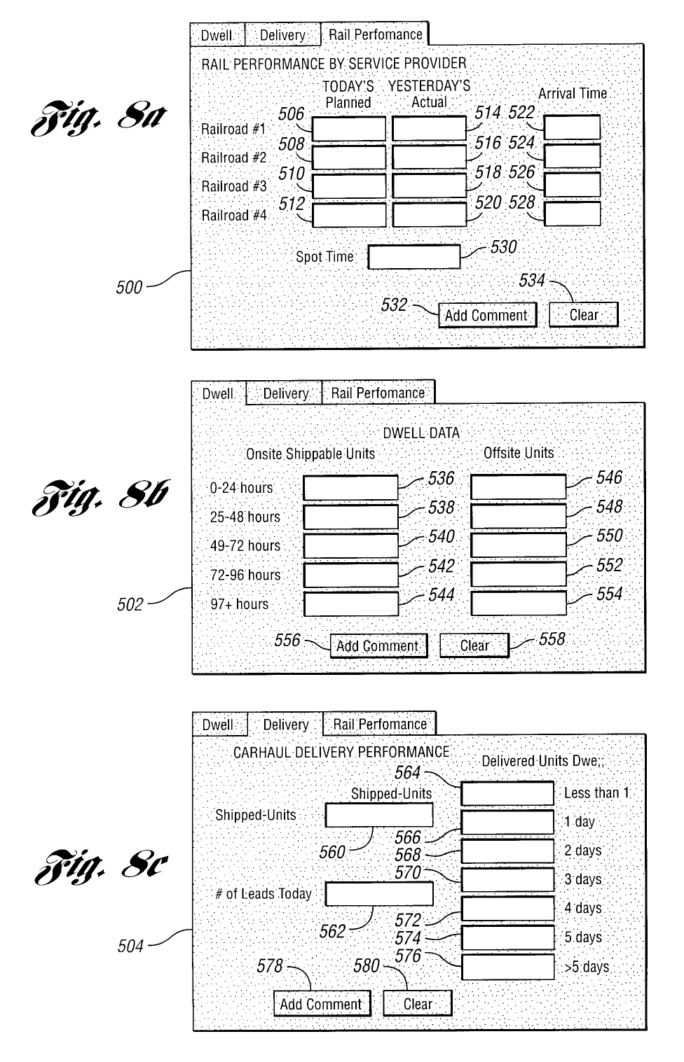

Tabbed area 312 can include rail performance tab 500, as depicted in FIG. 8a, dwell tab 502, is depicted in FIG. 8b, and delivery tab 504, as depicted in FIG. 8c.

Rail performance tab 500 can be used to input planned daily arrival information and total number of actual rail cars used. In certain embodiments, these values are entered in military time format xx.xx. For example, 2:15 p.m. is entered as 14.15. Data entry fields 506, 508, 510 and 512 can be used to enter planned arrival units for railroads #1, #2, #3 and #4, respectively. Data entry fields 514, 516, 518 and 520 can be used to input the total number of actual units that arrived in the previous day for railroads #1, #2, #3 and #4, respectively. Data entry fields 522, 524, 526 and 528 can be used to input the planned arrival times for railroads #1, #2, #3 and #4. Data entry field 530 can be used to input the spot time, e.g. the time when railcars are scheduled to be unloaded. Rail performance tab 500 includes “Add Comment” and “Clear” click buttons 532 and 534.

Dwell tab 502 is used to input the dwell time of shippable vehicles, i.e., the time from rail car spot until vehicle shipping to dealer. According to dwell tab 502, dwell time is broken down into hour ranges: 0-24 hours, 25-48 hours, 49-72 hours, 73-96 hours and 97+ hours. The number of onsite shippable units falling into each range of dwell time can be entered in data entry fields 536, 538, 540, 542 and 544, respectively. The number of offsite units falling into each dwell time range can be input into data entry fields 546, 548, 550, 552 and 554, respectively. Dwell GUI 502 also includes “Add Comment” and “Clear” click buttons 556 and 558.

Delivery tab 504 can be used to input the dwell time of delivered vehicle, i.e., from shipment to delivery. This information can be used to calculate average time in transit (TnT) and load ratio. TnT can be calculated by dividing total hold time by total inventory. The load ratio can be defined as how many cars fit in a convoy carrier, and this value typically depends on the vehicle size, weight, etc. Data entry field 560 can be used to input the total number of vehicles shipped in a day. Data entry field 562 can be used to input the number of loads in a day. Delivery tab 504 can also be used to input the range of dwell time for delivered units. Available ranges are less than one day, one day, two days, three days, four days, five days and greater than five days. The number of delivered units that fall into each range of dwell times can be input in data entry fields 564, 566, 568, 570, 572, 574 and 576, respectively. Delivery tab 504 includes “Add Comment” and “Clear” click buttons 578 and 580.

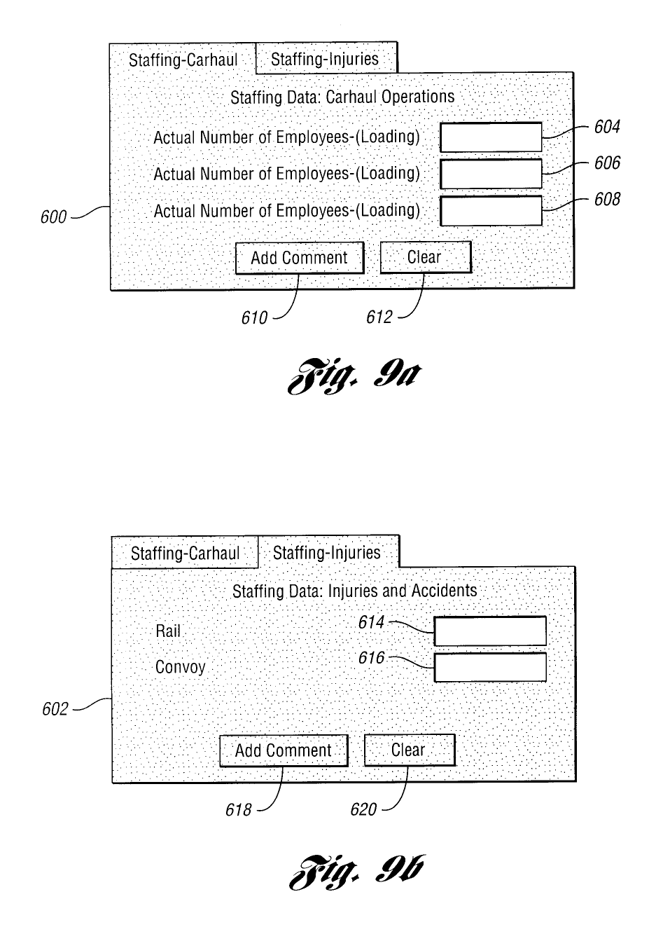

Tabbed area 314 includes tab carhaul staffing tab 600, as depicted in FIG. 9a, and staffing injuries tab 602, as depicted in FIG. 9b.

Carhaul staffing Tab 600 can be used to input staffing numbers for carhaul, if available. Data entry fields 604, 606 and 608 can be used to input the actual number of loading employees, actual drivers and planned drivers, respectively. Carhaul staffing tab 600 also includes “Add Comment” and “Clear” click buttons 610 and 612, respectively.

Staffing injuries tab 602 can be used to input the number of rail and convoy injuries and accidents through data entry fields 614 and 616. Staffing injuries tab 602 also includes “Add Comment” and “Clear” click button 618 and 620.

At any time during data entry into the tabs of GUI 300, the user can click on the “Save” click button 316 to save the entered information to database 44. GUI 300 also includes “Cancel” and “Help” click buttons 318 and 320.

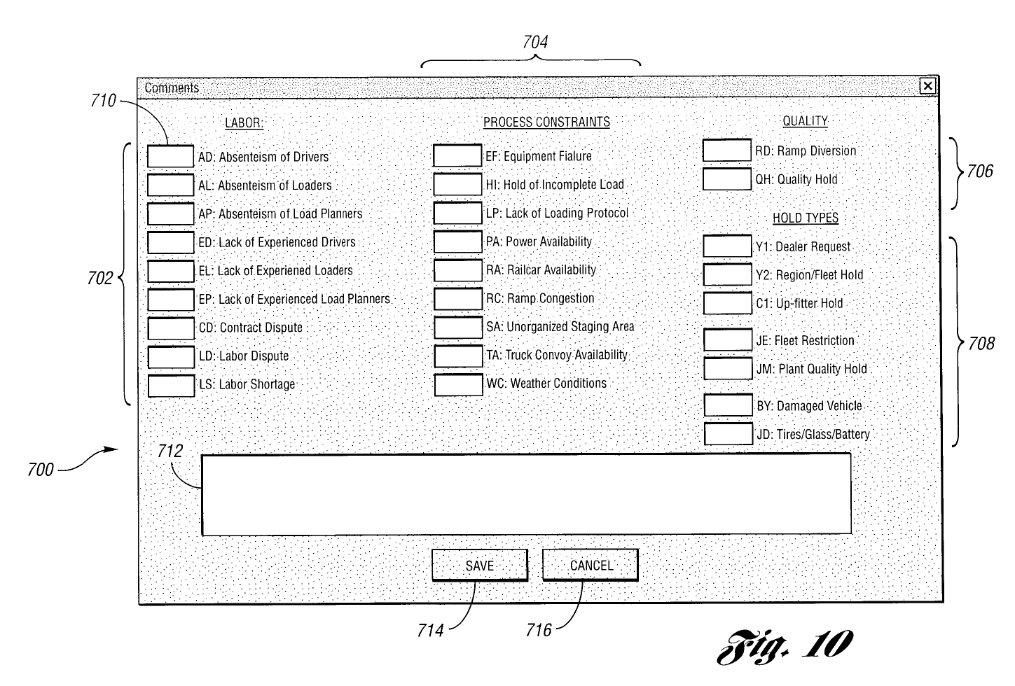

FIG. 10 depicts comments GUI 700 for adding comments to any field contained on the tabs of GUI 300. The comments are broken up into various sections: labor section 702, process constraints section 704, quality section 706 and hold type section 708. Each section includes one or more fields for entering a number of occurrences associated with a field description and associated identifier. For example, field 710 of labor section 702 can be used to indicate number of absenteeism of drivers (AO). Other selectable comments for labor section 702 include, but are not limited to: absenteeism of loaders (AL), absenteeism of load planners (AP), lack of experienced drivers (ED), lack of experienced loaders (EL), lack of experienced load planners (EP), contract dispute (CD), labor dispute (LD), and labor shortage (LS). Selectable comments of process constraints section 704 include, but are not limited to: equipment failure (EF), hold of incomplete loads (HI), lack of loading protocol (LP), power availability (PA), railcar availability (RA), ramp congestion (RC), unorganized staging area (SA), truck convoy availability (TA), and weather conditions (WC). Selectable comments of the quality section 706 include, but are not limited to: ramp diversion (RD) and quality hold (QH). Selectable comments of the hold types section 708 include, but are not limited to: dealer request (Y1), region/fleet hold (Y2), up-fitter hold (C1), fleet restriction (JE), plant quality hold (JM), damaged vehicle (BY), and tires/glass/battery (JD). GUI 700 also includes text box 712 for entering other comments not specifically identified in the comment section. GUI 700 includes “Save” click button 714 for saving comments and “Cancel” click button 716 for canceling comments GUI 700 and returning to one of the tabs of GUI 300.

When the “Save” click button 316 of GUI 300 is selected, the activity information input through the input tabs is populated into a monthly database, as depicted in block 82 of FIG. 3a. The monthly database can be database 44. As depicted in block 84 of FIG. 3a, constraints applicable to the activity reporting are processed to produce constrained activity reporting information, which is stored to the monthly database. The report can be generated for all constraint data input into the comment fields. According to block 86 of FIG. 3a, the populated data is checked for irregularities and errors.

In block 88 of FIG. 3a, ramp destination and logistics statistics can be calculated based on the populated data. The statistics can be calculated by using mathematical formulas known to one of ordinary skill in the art. For example, known six-sigma methodology can be used to calculate at least some of the statistics. Non-limiting examples of statistical calculations include compliance (a standard defined for each carrier), DFP, and/or dwell in transit, as depicted in blocks 90, 92 and 94 of FIG. 3b. The monthly database is populated with the results of the statistical analysis, as depicted in block 96 of FIG. 3b. Each of these calculations can be executed on a daily basis. Moreover, by use of the standardized GUI 300 and relational database 44 for a number of ramps in the destination ramp system, consistent and reliable statistics and reports can be generated on ramp, region, and system levels. Further, reports and statistics can be generated automatically for any time period.

In block 98 of flowchart 48, reports can be generated based on the activity and/or statistical data populated into the monthly database. Non-limiting examples of the reports that can be generated are graphical reports, daily reports and monthly process constraint summaries, as depicted in blocks 100, 102 and 104.

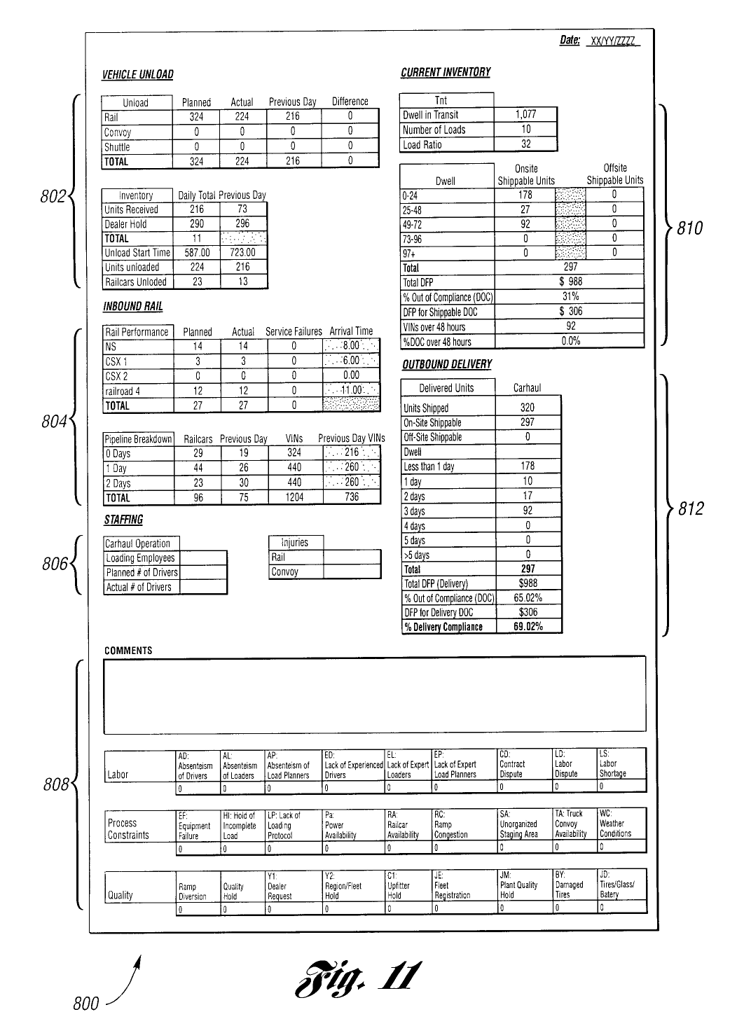

FIG. 11 depicts an example of a daily activity report 800 which can be generated by application 36. The daily activity report 800 displays the daily activity information input by the user and calculates values based on the daily activity information and a comparison of these values with the data of the previous day. The report can be generated through Microsoft Excel macros and displayed on a Microsoft Excel worksheet. The daily activity report 800 can include several report sections, for example, vehicle unload section 802, inbound rail section 804, staffing section 806, comments section 808, current inventory section 810, and outbound delivery section 812.

According to one or more embodiments of the present invention, reports can be generated for single ramps, for multiple ramps, for single regions or for multiple regions. This flexibility in the ability to report is a powerful tool for identifying issues in the destination ramp system, as well as for providing a sound basis for financial analysis.

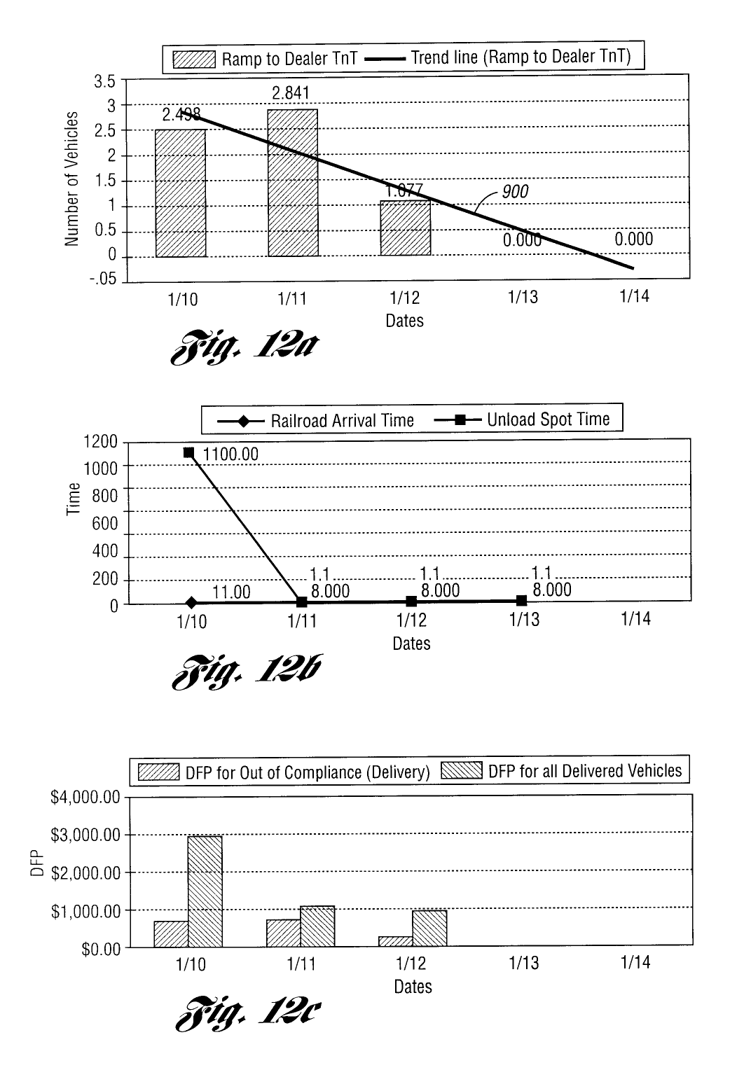

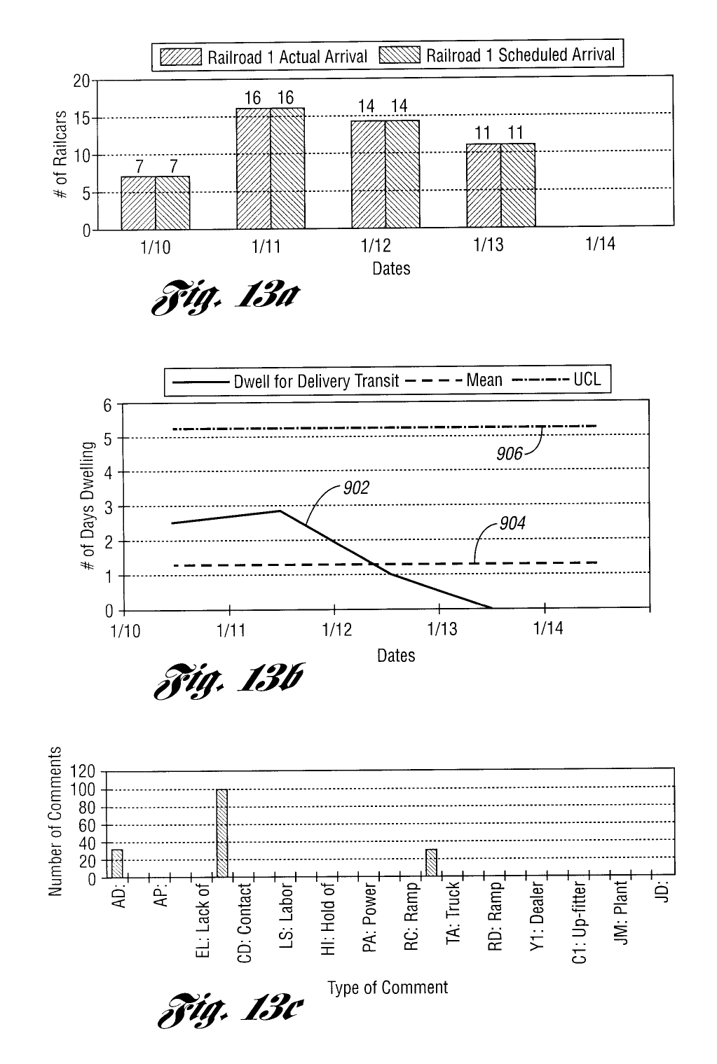

Examples of graphical reports include arrival versus unload time, time in transit versus time, daily dwell time, impact of process constraints, DFP for delivered units, scheduled versus actual rail car arrival and transit control charts. FIG. 12a is a graphical report of ramp to dealer time in transit (TnT) for a number of successive dates. Line 900 represents a trend line for ramp to dealer TnT. FIG. 12b is a graphical report of arrival and unload times for a number of dates for a specific railroad. FIG. 12b also includes unload spot time. FIG. 12c is a graphical report of DFP for delivered units (including out of compliance delivered units) for a number of dates. FIG. 13a is a graphical report of actual and proposed arrivals for a specific railroad. FIG. 13a includes actual arrivals and scheduled arrivals. FIG. 13b is a graphical report for dwell for vehicles in delivery. The graphical report includes lines for dwell 902, mean 904 and upper control limit (UCL) 906. FIG. 13c is graphical report summarizing comments by type of comment.

While the best mode for carrying out the invention has been described in detail, those familiar with the art to which this invention relates will recognize various alternative designs and embodiments for practicing the invention as defined by the following claims. For example, the monitoring system was described with reference to a destination ramp system. It should be understood that the methods and systems of the present invention can also be applied to outbound ramp systems and hybrid outbound/destination ramp systems.

What is claimed:

1. An electronic method for monitoring a number of destination ramps in a manufacturing enterprise which manufactures a number of products for purchase through a number of dealers, the method comprising the steps of:
receiving ramp profile information for a number of destination ramps, the ramp profile information including ramp contractor information;
for each of the number of destination ramps,
presenting a standardized electronic user interface for requesting and gathering destination ramp activity information including inbound product information and outbound convoy information, wherein the standardized electronic user interface is standardized for use with all of the number of destination ramps;
receiving the destination ramp activity information through the standardized electronic user interface;
populating an electronic database with the ramp profile information and the destination ramp activity information; and
calculating a carrying cost based on the ramp profile information and the destination ramp activity information.

2. The method of claim 1 wherein the receiving the destination ramp activity step, the populating step and the calculating step occur on a daily basis.

3. The method of claim 1 wherein a first destination ramp distributes products to a first and second dealer, a second destination ramp distributed products to a third and a fourth dealer, the first destination ramp and the first and second dealers are located in a first region, and the second destination ramp and the third and fourth destination ramps are located in a second region, and the calculating step includes calculating a carrying cost for the first and second regions.

4. The method of claim 1 further comprising receiving one or more constraints relating to the one or more destination ramps, and wherein the calculating step includes calculating the carrying cost based on the one or more constraints, the ramp profile information and the destination ramp activity information.

5. The method of claim 1 further comprising generating a graphical report relating to the ramp profile information and the destination ramp activity information.

6. The method of claim 5 wherein the graphical report is a graph plotting time in transit (TnT) versus date for a number of dates.

7. The method of claim 1 wherein the destination ramp activity information includes inventory information.

8. The method of claim 1 further comprising:
presenting a standardized comments user interface for requesting and gathering comment information relating to the destination ramp activity information upon a user request to annotate the destination ramp activity information;
receiving comment information relating to the destination ramp activity information; and
generating an electronic report based on the comment information.

9. The method of claim 1 wherein the number of products is a number of automotive vehicles.

10. A computer-implemented method for monitoring one or more destination ramps in a manufacturing enterprise which manufactures a number of products for purchase through a number of dealers, the method comprising the steps of:
receiving ramp profile information for one or more destination ramps and daily activity information for the one or more destinations ramps; and
calculating a carrying cost for each of the one or more destination ramps based on the daily activity information.

11. The computer-implemented method of claim 10 further comprising calculating a destination ramp to a dealer time in transit (TnT) for each combination of destination ramp and dealer based on the daily activity information.

12. The computer-implemented method of claim 11 wherein one or more carriers transport one or more of the products from the one or more destination ramps to one or more dealers, and the daily activity information includes carrier information, and further comprising calculating planned versus actual arrival time for each of the one or more carriers based on the daily activity information.

13. The computer-implemented method of claim 12 further comprising calculating unload time versus spot time for each of the one or more carriers based on the daily activity information.

14. The computer-implemented method of claim 10 wherein the number of products are a number of automotive vehicles.

15. A computer system operating to monitor one or more destination ramps in a manufacturing enterprise which manufactures a number of products for purchase through a number of dealers, the computer system including one or more computers, the one or more computers programmed to:
receive ramp profile information for one or more destination ramps and daily activity information for the one or more destinations ramps; and
calculate a carrying cost for each of the one or more destination ramps based on the daily activity information.

16. The computer system of claim 15, the one or more computers further programmed to calculate a destination ramp to a dealer time in transit (TnT) for each combination of destination ramp and dealer based on the daily activity information.

17. The computer system of claim 16, wherein one or more carriers transport one or more of the products from the one or more destination ramps to one or more dealers, and the daily activity information includes carrier information, and wherein the one or more computers are programmed to calculate planned versus actual arrival time for each of the one or more carriers based on the daily activity information.

18. The computer system of claim 17, wherein the one or more computers are programmed to calculate unload time versus spot time for each of the one or more carriers based on the daily activity information.

19. The computer system of claim 15, wherein the number of products are a number of automotive vehicles.

20. The computer system of claim 15, wherein a first destination ramp distributes products to a first and second dealer, a second destination ramp distributed products to a third and fourth dealer, the first destination ramp and the first and second dealers are located in a first region, and the second destination ramp and the third and fourth destination ramps are located in a second region, and the one or more computers are programmed to calculate a carrying cost for the first and second regions.
